(19) United States
(12) Patent Application Publication
(10) Pub. No.: US 2009/0195084 A1
(43) Pub. Date: Aug. 6, 2009

(54) Cellular phone and portable electronic device sun powered process

(76) Inventor: Todd Allen Bland, Omaha, NE (US)

Correspondence Address: Todd Allen Bland, 13708 Frederick Avenue, Omaha, NE, 68138, US

(21) Appl. No.: 12/284,731

(22) Filed: Sep. 25, 2008

Related U.S. Application Data
(60) Provisional application No. 61/062,926, filed on Jan. 31, 2008.

(51) Int. Cl. H02J 17/00

(52) U.S. Cl. 307/149

(57) ABSTRACT

Disclosed herein is a portable cellular phone or electronic device that is powered by a recharging process that does not employ conventional methods of recharging cellular phones such as AC 110V/220V into DC power or by a solar panel connected to said cellular phone or electronic device. The new process utilizes the sun's energy rays collected by solar panels from an orbiting space station or satellite and then beamed to earth solar power stations by low density microwaves (Microwave-Beaming Technology) or alternatively laser beams which are beamed to “rectenna” rectifying Antenna receiver which converts the energy into DC current and then transmitted to cellular phones or portable digital assistants (PDA).

### GENERAL STATEMENT OF THE INVENTION

With the above mentioned general objective in view, and together with other related and ancillary objectives, which will become more apparent as this description proceeds: The herein “CELLULAR PHONE AND PORTABLE ELECTRONIC DEVICE SUN POWERED PROCESS” of the present invention generally comprises: The sun beaming it's energy ray's to a collective earth orbiting satellite or space stations matrix of geostationary solar panels then magnified through a stretched Fresnel lens (commercially available) which are then collected onto tiny photovoltaic cells of the solar panels as the space station or satellite orbits the earth. Energy in the form of preferably microwaves and alternatively lasers are thereby transmitted by low-density microwaves to the said solar power stations on earth, whereby the solar panels collected energy is then transmitted to (rectenna) rectifying antenna receiver which coverts the energy to DC current, and then beams the current to the cellular phones and or portable electronic devices. Microwaves are low-power microwaves with low energy density beams and will not harm humans, animal or plant life. Low-power microwaves will not interfere with radio transmission or mobile phone communications.

### TECHNICAL FIELD

The present powering of and recharging of a portable charger of a cellular phone or portable electronic device and more specifically, to a portable charger having a built-in charging battery capable of easily charging a charging battery of a portable electronic device even in a place where domestic AC power or car power cannot be used for charging the battery.

### BACKGROUND OF THE INVENTION

A conventional charging device for charging a battery of a cellular phone or portable electronic device includes a desk top charger, a portable charger that travelers use, a vehicle charger utilizing a cigarette jack power of said vehicle and so on. The portable charger rectifies domestic AC 110V/220V into DC power with a predetermined voltage level suitable for charging, to the charging battery of the portable electronic device.

### GENERAL OBJECTIVE OF THE INVENTION

To overcome the limitations of conventional, powering and recharging methods of typical cellular phones or portable electronic devices or the like.

From the foregoing, the construction of the new process for powering cellular phones and the like will be readily understood and further explanation is believed to be unnecessary, however, since numerous modifications and changes will readily occur to those skilled in the art, it is not desired to limit the invention to the exact process shown and described and all suitable modifications and equivalents will be resorted to, falling within the scope of the appended claims.

What is claimed:

1. For the environment of a typical charging and powering of a conventional cellular phone utilizing a recharging means for charging a battery or other portable electronic device including a desktop charger (DTC), a portable charger that travelers use, a vehicle charger in which a cigarette jack power of a car is used as a charging power and so on. Furthermore, the portable charger rectifies domestic AC 110V/220V into DC power and steps it down using a switch mode power with a predetermined voltage level suitable for charging, to the charging battery of the portable electronic device the improvement comprising: A cellular phone or portable electronic device is now powered and rechargeable by DC current transmitted from a “rectenna” rectifying antenna receiver which converts energy collected from low density microwaves transmitted to it by earth solar power stations which collect energy in the form of beaming microwaves which are beamed to the solar power stations from orbiting space stations or satellites which collect energy from the sun's ray's focused onto it's solar panels through a stretched Fresnel lens and onto tiny photvoltic cells located on the geostationary solar panels of the said orbiting space station or satellite.
